(19) United States
(12) Patent Application Publication
(10) Pub. No.: US 2024/0012965 A1
(43) Pub. Date: Jan. 11, 2024

(54) STEADY FLOW PREDICTION METHOD IN PLANE CASCADE BASED ON GENERATIVE ADVERSARIAL NETWORK

(71) Applicant: DALIAN UNIVERSITY OF TECHNOLOGY, Dalian, Liaoning (CN)

(72) Inventors: Bin YANG, Dalian, Liaoning (CN); Xinyuan ZHANG, Dalian, Liaoning (CN); Ximing SUN, Dalian, Liaoning (CN); Fuxiang QUAN, Dalian, Liaoning (CN)

(21) Appl. No.: 17/920,167

(22) PCT Filed: Dec. 27, 2021
(86) PCT No.: PCT/CN2021/141541

§ 371 Date: Oct. 20, 2022

(30) Foreign Application Priority Data
Dec. 22, 2021 (CN) 202111577346.4

(51) Int. Cl. G06F 30/27; G06F 30/28

(52) U.S. Cl. CPC G06F 30/27; G06F 30/28

(57) ABSTRACT

A steady flow prediction method in a plane cascade based on a generative adversarial network is provided. Firstly, CFD simulation experimental data in the plane cascade are preprocessed, and a test dataset and a training dataset are divided from the simulation experimental data. Then, an Encoding-Forecasting network module, a deep convolutional network module and a generative adversarial network prediction model are constructed successively. Finally, prediction is conducted on test set data: the test set data is preprocessed in the same manner, and data dimensions are adjusted according to input requirements of a saved optimal prediction model; and flow field images in the plane cascade at an inlet attack angle of 10° are obtained through the prediction model. The present invention can effectively avoid the problem of limited measurement range of sensors in an axial flow compressor, and the prediction result is highly consistent with the calculation result of CFD.

### TECHNICAL FIELD

The present invention relates to a steady flow prediction method in a plane cascade based on a generative adversarial network, and belongs to the technical field of aero-engine modeling and simulation.

### BACKGROUND

Aero-engine is a crown pearl of modern industry, and is of great significance to the development of military and civil aspects of the country. Stable operation of an axial flow compressor as a core component of aero-engine directly determines the operation performance of the aero-engine. Rotating stall and surge are two common unsteady flow phenomena in the axial flow compressor. These abnormal flow phenomena will lead to failure of the axial flow compressor, thereby affecting the operation state of the aero-engine. Therefore, it is very important to predict the unsteady flow of fluid in the axial flow compressor in time for ensuring the stable operation of the aero-engine.

There are two traditional methods to detect and discriminate the stability of the axial flow compressor: the first method is to study the mechanism of rotating stall and surge in the axial flow compressor, and to establish equations by mathematical and physical methods to obtain a model to simulate the flow field of the axial flow compressor. However, due to systematic uncertainty and complexity of internal evolution caused by the complex interaction of various factors in an axial flow compressor system, the model cannot accurately reflect the variation tendency of the flow field of the axial flow compressor. The other method is to analyze the state characteristics of signals using time domain analysis, frequency domain analysis and time-frequency analysis algorithms based on the data collected by sensors at different measuring points in the axial flow compressor, so as to avoid the occurrence of unstable state. Compared with the finite range of data, collected by the sensors at fixed measuring points, in the axial flow compressor, an image of flow field in a plane cascade of the axial flow compressor can reflect the flow field changes in the whole axial flow compressor more intuitively and clearly. With the development of artificial intelligence, image sequence data has become a kind of extremely important data in the real world, and the application of deep learning technology in the field of image sequence prediction has gradually become mature. At present, image sequence prediction is more applied in the fields of automatic driving and weather forecast, and obtains good progress. The prediction of the flow field in China and abroad is still in a preliminary exploration stage. The application of an image sequence prediction technology to steady flow prediction in the plane cascade has a bright prospect.

Because the aero-engine is sophisticated equipment and is complex in experimental operation, it is difficult to obtain the experimental data of the image of flow field in the axial flow compressor. Computational Fluid Dynamics (CFD) technology makes great progress in solving the problem. Image sequence data of flow field change in the plane cascade under different conditions can be obtained through CFD simulation experiments. The representation of the image of steady flow field in plane cascade at historical time is extracted by using a generative adversarial network model based on a data-driven method of the CFD simulation experiments, and the flow field in the fast changing axial flow compressor is predicted, to effectively avoid the problem of limited measurement range of the sensors in the axial flow compressor.

### SUMMARY

In view of problems of low accuracy and poor reliability in the prior art, the present invention provides a steady flow prediction method in a plane cascade based on a generative adversarial network.

The technical solution of the present invention is as follows:
The steady flow prediction method in the plane cascade based on the generative adversarial network comprises the following steps:
S1. preprocessing simulation image data of a flow field in a plane cascade of an axial flow compressor, comprising the following steps:
S1.1 because experimental data of flow field in the axial flow compressor of an aero-engine is difficult to obtain, obtaining image data of the steady flow field in the plane cascade of the axial flow compressor through CFD simulation experiments, wherein simulation experiment data involves blade profile, Mach number and inlet flow angle conditions; the inlet attack angle changes with time as 0°, 1°, 2°, . . . , 9°, 10°, . . . , which is positively correlated with time; under the conditions of the same blade profile, Mach number and inlet flow angle, an image sequence is formed as a sample from flow field images with the change of an inlet attack angle over time. The experiment is the input of isometric sequences, so redundant data in the samples are eliminated to ensure that the length of image sequences in each sample is consistent. There are 12 groups of sample datasets, and the length of the image sequences in each group of samples has 11 frames, i.e., the image sequence of the flow field in the plane cascade under the inlet attack angle 0°, 1°, 2°, 3°, . . . , 9°, 10°. To ensure the objectivity of test results, dividing simulation experimental data into a test dataset and a training dataset before processing;
S1.2 using median filtering, mean filtering and Gauss filtering to denoise the flow field image data;
S1.3 cutting the filtered flow field images to obtain the flow field image at the edge of the plane cascade, uniformly adjusting the resolution of the cut images as 256×256 through linear interpolation, and normalizing training dataset;
S1.4 with the image sequence length of each sample as 11 frames, using the first 10 frames of images as network input values and using a last frame as a target truth of image prediction;
S1.5 dividing the training dataset into a training datasetand a validation datasetin a ratio of 4:1.
S2. Constructing an Encoding-Forecasting network module, comprising the following steps:
S2.1 adjusting the dimension of each input sample in the training datasetas (seq_input, c, h, w), and adjusting the dimension of the target truth of image prediction as (seq_target, c, h, w), wherein seq_input is the length of an input image sequence, seq_target is the length of a predicted image sequence, c represents the number of image channels, and (h,w) is the image resolution;
S2.2 an Encoding network is composed of a plurality of encoding modules; the image sequence of the flow field in the plane cascade has high-dimensional features. The encoding modules reduces the dimension of the high-dimensional features, eliminate minor features in the image sequence of the flow field, and extract effective spatial-temporal features. In addition, there are large areas of flow field regions that move slowly and do not change obviously in the images of the steady flow field in the plane cascade; the low-level encoding module can extract local spatial structure features of the flow field, so as to capture the change details of the flow field region; the high-level encoding module can extract a wider range of spatial features by increasing a receptive field to capture the features of abrupt change of flow field near the blade leading edge in the images of the flow field in the plane cascade; each encoding module is composed of a down-sampling layer and a ConvLSTM layer; the effect of the down-sampling layer is to reduce the calculation amount and increase the receptive field; the effect of the ConvLSTM layer is to capture the nonlinear spatial-temporal evolution features of the flow field; each ConvLSTM layer contains a plurality of ConvLSTM units; the output of the down-sampling layer is input to the ConvLSTM layer through a gated activation unit, and each encoding module is connected with each other through the gated activation unit; each encoding module learns the high-dimensional spatial-temporal features of the flow field image sequence, outputs low-dimensional spatial-temporal features and transmits the features to a next encoding module;
S2.3 a Forecasting network is composed of a plurality of decoding modules; the effect of the decoding modules is to expand the low-dimensional flow spatial-temporal features extracted by the encoding modules into high-dimensional features to achieve the purpose of finally reconstructing the high-dimensional flow field image; each decoding module is composed of an up-sampling layer and a ConvLSTM layer; the effect of the up-sampling layer is to expand the feature dimension; each ConvLSTM layer contains a plurality of ConvLSTM units; the output of the ConvLSTM layer is input to the up-sampling layer through the gated activation unit, and each decoding module is connected with each other through the gated activation unit; each decoding module decodes the spatial-temporal features of the input image sequence extracted by the encoding module in the same position of the Encoding network, obtains the feature information of a historical moment and transmits the feature information to a next decoding module;
S2.4 outputting the spatial-temporal features of different dimensions in the extracted flow field image sequence in the plane cascade by different encoding layers of the Encoding network, and using the spatial-temporal features of different dimensions as initial state input of different decoding layers by the Forecasting network;
S2.5 to ensure that the input image and the predicted image have the same resolution, making the output features of the last decoding module in the Forecasting network pass through a convolutional layer, and activating by a ReLu activation function to generate and output a final predicted image; and using the final predicted image as a prediction result of Encoding-Forecasting network, with dimension of (N,seq_target,c,h,w), wherein N is the number of samples.
S3. Constructing a deep convolutional network module, comprising the following steps:
S3.1 adjusting the target truth of image prediction in step S1.4 and the dimension of the prediction result of the Encoding-Forecasting network obtained in step S2.5 as (N*seq_target,c,h,w) and using the same as the input of the deep convolutional network;
S3.2 connecting the convolutional layer, a batch normalization layer and a LeakyRelu activation function sequentially to form a convolutional module, wherein the deep convolutional network module is composed of a plurality of convolutional modules and an output mapping module, the output mapping module makes the features extracted by the plurality of convolutional modules pass through a convolutional layer, uses a sigmoid activation function to obtain an output value between 0 and 1, and then performs dimensional transformation on the output value to obtain a probability output value; and using the probability output value as the final output of the deep convolutional network module with dimension of (N*seq_target,1). The probability value represents a probability that the deep convolutional network determines that the image is a true image, and is marked as 1 for the true image and 0 for the predicted image of the Encoding-Forecasting network.
S4. Constructing a generative adversarial network prediction model, comprising the following steps:
S4.1 because the flow field prediction image obtained by using the Encoding-Forecasting network alone has the problem of fuzzy details, using a generative adversarial network training mode so that the deep convolutional network module provides a learning gradient for the Encoding-Forecasting network to further optimize the parameters of the Encoding-Forecasting network; using the Encoding-Forecasting network constructed in step S2 as a generator of the generative adversarial network, marked as G; and using the deep convolutional network module constructed in step S3 as a discriminator of the generative adversarial network, marked as D;
S4.2 because the Encoding-Forecasting network module can be used as an independent prediction network, it has certain reliability for the prediction of the flow field images. In addition, the premature application of the discriminator may lead to instability in the training process. Therefore, the present invention uses a strategy of individually training the Encoding-Forecasting network, and adding the deep convolutional network module as the discriminator for forming a generative adversarial network for joint training when an error value is less than 0.001, to achieve the purpose of stabilizing a training process and further restoring the details of the flow field image.

Firstly, the Encoding-Forecasting network is trained individually by the MSE loss function, and the MSE loss function is:

$${L}_{MSE} = \frac{1}{N} \sum {( G ( X ) - Y )}^{2}$$

wherein X=(X¹, . . . , X^{m}) represents the input image sequence, Y=(Y¹, . . . Yⁿ) represents a prediction target image sequence, G(X) represents the predicted image sequence of the Encoding-Forecasting network, and N is the number of samples;
S4.3 when the training error of the Encoding-Forecasting network module in step S4.2 is less than 0.001, forming the generative adversarial network from the network module and the deep convolutional network module for training, wherein the optimization objective function of the traditional generative adversarial network is formed by the optimization objective functions of two parts: a generator and a discriminator. The specific form is:

$${min}_{G} {max}_{D} V ( D , G ) = \frac{1}{N} \sum [ log ( D ( Y ) ) + log ( 1 - D ( G ( X ) ) ) ]$$

wherein D(⋅) represents a probability value output by the deep convolutional network module after processing the input data.

In the present invention, the discriminator uses a discriminator part L D in a traditional generative adversarial network loss function for training, with a calculation mode as follows:

$${L}_{D} = - V ( D , G ) = - \frac{1}{N} \sum [ log ( D ( Y ) ) + log ( 1 - D ( G ( X ) ) ) ]$$

for the unstable training of the generator in the generative adversarial training, an improved generator loss function is designed. The improved generator loss function is composed of two parts:
one part is a generator part L_{adv} in the traditional generative adversarial network loss function, with a calculation mode as follows:

$${L}_{adv} = V ( D , G ) = \frac{1}{N} \sum log ( 1 - D ( G ( X ) ) )$$

the other part is an MSE loss function L_{MSE}, which is used to ensure the stability of generator model training; at the same time, weight parameters λ_{adv} and λ_{MSE} are used to adjust the loss function L_{adv} and L_{MSE} to achieve the purpose of balancing the training stability and the clarity of the prediction result, and thus, the final loss function of the generator is:

L_{G}=λ_{adv}L_{adv}+λ_{MSE}L_{MSE}

wherein λ_{adv}∈(0,1) and λ_{MSE}∈(0,1);
therefore, the loss function of the entire generative adversarial network is:

Lₜₒₜₐₗ=L_{D}+L_{G}
S4.4 saving the generative adversarial network trained in step S4.3 and testing on the validation dataset; adjusting the hyperparameter of the model according to an evaluation index of the validation dataset; adopting a structural similarity (SSIM) index as the evaluation index; and saving a model which makes the evaluation index optimal to obtain a final generative adversarial network prediction model;
two images x and y are provided, and the SSIM index is:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )}$$

wherein μₓ is the average value of x; μ_{y} is the average value of y; σₓ² is the variance of x; σ_{y}² is the variance of y; σ_{xy} is the covariance of x and y. c₁=(k₁L)² and c₂=(k²L)² are constants used to maintain the stability. L is the dynamic range of a pixel value. k₁=0.01 and k₂=0.03. The value range of SSIM is [0,1]; and if the value is close to 1, the structures of the two images are similar.
S5. Predicting test data by the prediction model;
S5.1 preprocessing the test dataset of step S1.1 according to steps in step S1, and adjusting data dimension of the test dataset according to input requirements in step S2.1 and step S3.1;
S5.2 predicting the image of the last frame of each test sample by the final generative adversarial network prediction model in step S4.4 to obtain the flow field prediction image in the plane cascade when the inlet attack angle is 10°.

Beneficial effects of the present invention: the method provided by the present invention is used for predicting the flow field image of the steady flow field in the plane cascade of the axial flow compressor; compared with the traditional method, the present invention can effectively extract and use the spatial-temporal features of the image sequences of the flow field, and can intuitively and clearly reflect the flow field changes in the axial flow compressor on the premise of ensuring the prediction accuracy. At the same time, the model prediction results in the present invention are in good coincidence with the CFD calculation results, and the features of the flow field in the plane cascade under different blade profiles and Mach numbers as a function of the inlet attack angle can be learned. Moreover, compared with CFD, the present invention saves computing resources and can replace the flow field simulation data required by CFD generation under the condition of ensuring effectiveness. The present invention is on a data-driven basis; and the model can be conveniently applied to the flow field prediction of the axial flow compressor with different blade profiles by training different datasets, which has certain universality.

### DESCRIPTION OF DRAWINGS

FIG. 1 is a flow chart of a steady flow prediction method in a plane cascade based on a generative adversarial network;

FIG. 2 is a flow chart of data preprocessing;

FIG. 3 is a structural diagram of a ConvLSTM unit;

FIG. 4 is a structural diagram of an Encoding-Forecasting model;

FIG. 5 is a structural diagram of a generative adversarial network model; and

FIG. 6 shows three examples selected from the prediction result diagram of a generative adversarial network on test data, wherein (a), (c) and (e) are the real flow field images in the plane cascades with different blade profiles at an inlet attack angle of 10°, and (b), (d) and (f) are the predicted flow field images in the plane cascades with different blade profiles at an inlet attack angle of 10°.

### DETAILED DESCRIPTION

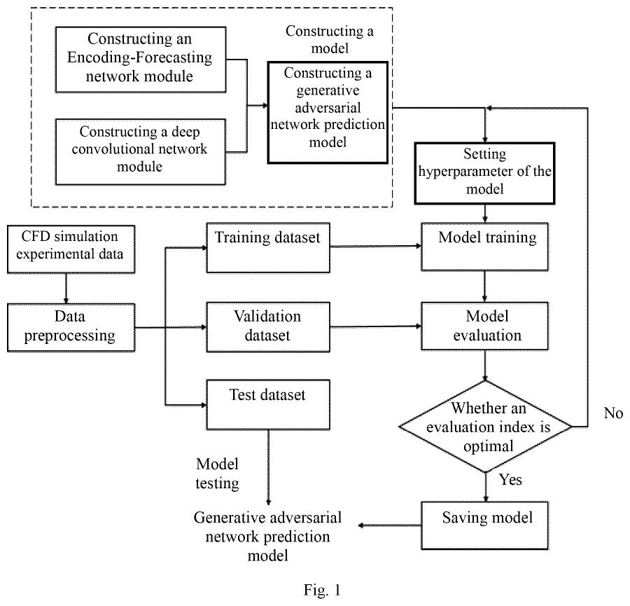

The present invention is further described below in combination with the drawings. The present invention relies on the background of CFD simulation data of the flow field in the plane cascade of the axial flow compressor, and the process of a steady flow prediction method in a plane cascade based on a generative adversarial network is shown in FIG. 1.

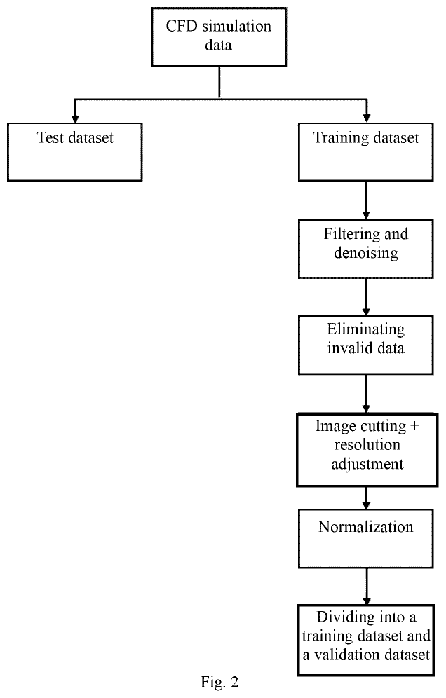

FIG. 2 is a flow chart of data preprocessing, with the data preprocessing steps as follows:
S1. preprocessing image data of a flow field in a plane cascade of an axial flow compressor, comprising the following steps:
S1.1 because experimental data of flow field in the axial flow compressor of an aero-engine is difficult to obtain, obtaining image data of the steady flow field in the plane cascade of the axial flow compressor through CFD simulation experiments, wherein simulation experiment data involves blade profile, Mach number and inlet flow angle conditions; the inlet attack angle changes with time as 0°, 1°, 2°, . . . , 9°, 10°, . . . , which is positively correlated with time; under the conditions of the same blade profile, Mach number and inlet flow angle, an image sequence is formed as a sample from flow field images with the change of an inlet attack angle over time. The experiment is the input of isometric sequences, so redundant data in the samples are eliminated to ensure that the length of image sequences in each sample is consistent. There are 12 groups of sample datasets, and the length of the image sequences in each group of samples has 11 frames, i.e., the image sequence of the flow field in the plane cascade under the inlet attack angle 0°, 1°, 2°, 3°, . . . , 9° and 10°. To ensure the objectivity of test results, dividing simulation experimental data into a test dataset and a training dataset before processing;
S1.2 using median filtering, mean filtering and Gauss filtering methods to denoise the flow field image data;
S1.3 cutting the filtered flow field images to obtain the flow field image at the edge of the plane cascade, uniformly adjusting the resolution of the cut images as 256×256 through linear interpolation, and normalizing training dataset;
S1.4 with the image sequence length of each sample as 11 frames, using the first 10 frames of images as network input values and using a last frame as a target truth of prediction;
S1.5 dividing the training dataset into a training dataset and a validation datasetin a ratio of 4:1. To ensure that the model has adaptability to various blade profiles, the validation dataset needs to contain samples of different blade profiles.

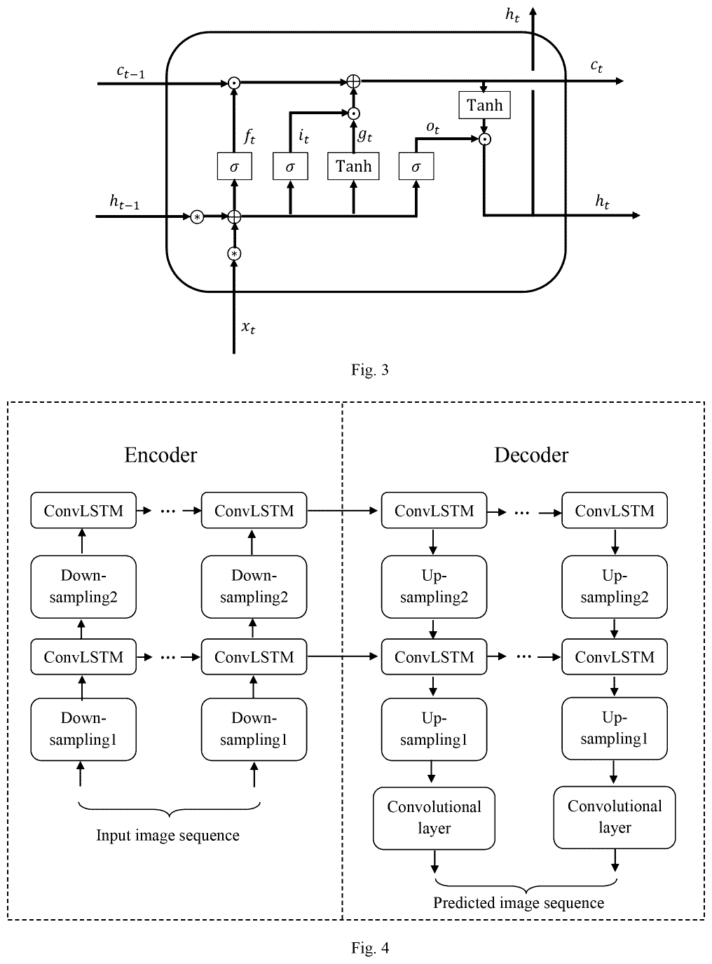

FIG. 3 shows the internal structure of a ConvLSTM unit: the main defect of the traditional LSTM unit in processing spatial-temporal data is that full connection is used in input-to-state and state-to-state transformation, wherein there is no spatial information encoding. ConvLSTM uses convolution operators in input-to-state and state-to-state transformation to determine the function of the future state of a unit through the hidden state information of the input and history near the unit in the space.

Thus, the input, unit output and unit state of ConvLSTM will be three-dimensional tensors, with the first dimension of the number of channels, and the second and third dimensions representing the image resolution of the output. The input, unit output and unit state of the traditional LSTM can be regarded as three-dimensional tensors with the last two dimensions of 1. In this sense, the traditional LSTM is actually a special case of ConvLSTM. If the state of the unit in the space is regarded as the hidden representation of a moving object, ConvLSTM with large convolutional kernel should be able to capture faster motion, while ConvLSTM with small convolutional kernel should be able to capture slower motion.

The formula of forward propagation of ConvLSTM is:

iₜ=Sigmoid(Conv(xₜ;wₓₜ)+Conv(hₜ₋₁;wₕₜ)+bₜ)

fₜ=Sigmoid(Conv(xₜ;w_{xf})+Conv(hₜ₋₁;w_{hf})+b_{f})

oₜ=Sigmoid(Conv(xₜ;wₓₒ)+Conv(hₜ₋₁;wₕₒ)+bₒ)

gₜ=Tan h(Conv(xₜ;w_{xg})+Conv(hₜ₋₁;w_{hg})+b_{g})

cₜ=fₜ⊙cₜ₋₁+iₜ⊙gₜ

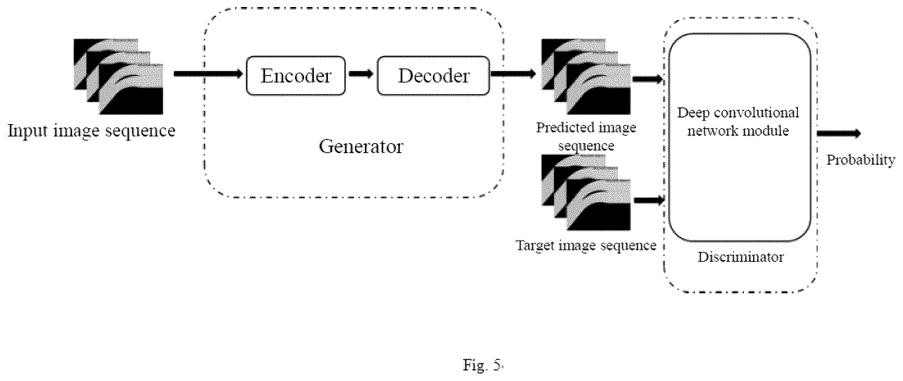

hₜ=oₜ⊙ Tan h(cₜ)

wherein hₜ represents the output of the unit at the current time; hₜ₋₁ represents the output of the unit at the previous time; cₜ is the state of the unit at the current time; cₜ₋₁ represents the state of the unit at the previous time; ⊙ represents Hadamard product; Conv( ) represents convolutional operation; iₜ [symbol] fₜ [symbol] oₜ represent an input gate, a forget gate and an output gate respectively; w represents weight; b represents bias; Tan h( ) represents a hyperbolic tangent activation function; and sigmoid( ) represents a sigmoid activation function.
S2. Constructing an Encoding-Forecasting network module, comprising the following steps:
S2.1 Encoding-Forecasting network structure is shown in FIG. 4, wherein an encoder is an Encoding network and a decoder is a Forecasting network. Adjusting the dimension of each input sample in the training datasetas (seq_input, c, h, w), and adjusting the dimension of the target truth of image prediction as (seq_target, c, h, w), wherein seq_input is the length of an input image sequence, seq_target is the length of a predicted image sequence, c represents the number of image channels, and (h,w) represents the image resolution;
S2.2 an Encoding network is composed of a plurality of encoding modules; the image sequence of the flow field in the plane cascade has high-dimensional features. The encoding modules reduces the dimension of the high-dimensional features, eliminate minor features in the image sequence of the flow field, and extract effective spatial-temporal features. In addition, there are large areas of flow field regions that move slowly and do not change obviously in the images of the steady flow field in the plane cascade; the low-level encoding module can extract local spatial structure features of the flow field, so as to capture the change details of the flow field region; the high-level encoding module can extract a wider range of spatial features by increasing a receptive field to capture the features of abrupt change of flow field near the blade leading edge in the images of the flow field in the plane cascade; each encoding module is composed of a down-sampling layer and a ConvLSTM layer; the effect of the down-sampling layer is to reduce the calculation amount and increase the receptive field; the effect of the ConvLSTM layer is to capture the nonlinear spatial-temporal evolution features of the flow field; each ConvLSTM layer contains a plurality of ConvLSTM units; the output of the down-sampling layer is input to the ConvLSTM layer through a gated activation unit, and each encoding module is connected with each other through the gated activation unit; each encoding module learns the high-dimensional spatial-temporal features of the flow field image sequence, outputs low-dimensional spatial-temporal features and transmits the features to a next encoding module;
S2.3 a Forecasting network is composed of a plurality of decoding modules; the effect of the decoding modules is to expand the low-dimensional flow spatial-temporal features extracted by the encoding modules into high-dimensional features to achieve the purpose of finally reconstructing the high-dimensional flow field image; each decoding module is composed of an up-sampling layer and a ConvLSTM layer; the effect of the up-sampling layer is to expand the feature dimension; each ConvLSTM layer contains a plurality of ConvLSTM units; the output of the ConvLSTM layer is input to the up-sampling layer through the gated activation unit, and each decoding module is connected with each other through the gated activation unit; each decoding module decodes the spatial-temporal features of the input image sequence extracted by the encoding module in the same position of the Encoding network, obtains the feature information of a historical moment and transmits the feature information to a next decoding module;
S2.4 outputting the spatial-temporal features of different dimensions in the extracted flow field image sequence in the plane cascade by different encoding layers of the Encoding network, and using the spatial-temporal features of different dimensions as initial state input of different decoding layers by the Forecasting network;
S2.5 to ensure that the input image and the predicted image have the same resolution, making the output features of the last decoding module in the Forecasting network pass through a convolutional layer, and activating by a ReLu activation function to generate and output a final predicted image; and using the final predicted image as a prediction result of Encoding-Forecasting network, with dimension of (N,seq_target,c,h,w), wherein N is the number of samples.
S3. Constructing a deep convolutional network module, comprising the following steps:
S3.1 adjusting the target truth of image prediction in step S1.4 and the dimension of the prediction result of the Encoding-Forecasting network obtained in step S2.5 as (N*seq_target,c,h,w) and using the same as the input of the deep convolutional network;
S3.2 connecting the convolutional layer, a batch normalization layer and a LeakyRelu activation function sequentially to form a convolutional module, wherein the deep convolutional network module is composed of a plurality of convolutional modules and an output mapping module, and the output mapping module has the effects of making the features extracted by the plurality of convolutional modules pass through a convolutional layer, using a sigmoid activation function to obtain an output value between 0 and 1, and then performing dimensional transformation on the output value to obtain a probability output value; and using the probability output value as the final output of the deep convolutional network module with dimension of (N*seq_target,1). The probability value represents a probability that the deep convolutional network determines that the image is a true image, and is marked as 1 for the true image and 0 for the predicted image of the Encoding-Forecasting network.
S4. Constructing a generative adversarial network prediction model, comprising the following steps:
S4.1 generative adversarial network model structure is shown in FIG. 5, wherein an encoder is an Encoding network and a decoder is a Forecasting network.

Because the flow field prediction image obtained by using the Encoding-Forecasting network alone has the problem of fuzzy details, using a generative adversarial network training mode so that the deep convolutional network module provides a learning gradient for the Encoding-Forecasting network to further optimize the parameters of the Encoding-Forecasting network; using the Encoding-Forecasting network constructed in step S2 as a generator of the generative adversarial network, marked as G; and using the deep convolutional network module constructed in step S3 as a discriminator of the generative adversarial network, marked as D;
S4.2 because the Encoding-Forecasting network module can be used as an independent prediction network, it has certain reliability for the prediction of the flow field images. In addition, the premature application of the discriminator may lead to instability in the training process. Therefore, the present invention uses a strategy of individually training the Encoding-Forecasting network, and adding the deep convolutional network module as the discriminator for forming a generative adversarial network for joint training when an error value is 0.0009, to achieve the purpose of stabilizing a training process and further restoring the details of the flow field image.

Firstly, the Encoding-Forecasting network is trained individually by the MSE loss function, and the MSE loss function is:

$${L}_{MSE} = \frac{1}{N} \sum {( G ( X ) - Y )}^{2}$$

wherein X=(X¹, . . . , X^{m}) represents the input image sequence, Y=(Y¹, . . . Yⁿ) represents a prediction target image sequence, G(X) represents the predicted image sequence of the Encoding-Forecasting network, and N is the number of samples.
S4.3 When the training error of the Encoding-Forecasting network module in step S4.2 is 0.0009, forming the generative adversarial network from the network module and the deep convolutional network module for training, wherein the optimization objective function of the traditional generative adversarial network is formed by the optimization objective functions of two parts: a generator and a discriminator. The specific form is:

$${min}_{G} {max}_{D} V ( D , G ) = \frac{1}{N} \sum [ log ( D ( Y ) ) + log ( 1 - D ( G ( X ) ) ) ]$$

wherein D(⋅) represents a probability value output by the deep convolutional network module after processing the input data.

In the present invention, the discriminator uses a discriminator part L D in a traditional generative adversarial network loss function for training, with a calculation mode as follows:

$${L}_{D} = - V ( D , G ) = - \frac{1}{N} \sum [ log ( D ( Y ) ) + log ( 1 - D ( G ( X ) ) ) ]$$

for the unstable training of the generator in the generative adversarial training, an improved generator loss function is designed. The improved generator loss function is composed of two parts:
one part is a generator part L_{adv} in the traditional generative adversarial network loss function, with a calculation mode as follows:

$${L}_{adv} = V ( D , G ) = \frac{1}{N} \sum log ( 1 - D ( G ( X ) ) )$$

the other part is an MSE loss function L_{MSE}, which is used to ensure the stability of generator model training; at the same time, weight parameters λ_{adv} and λ_{MSE} are used to adjust the loss function L_{adv} and L_{MSE} to achieve the purpose of balancing the training stability and the clarity of the prediction result, and thus, the final loss function of the generator is:

L_{G}=λ_{adv}L_{adv}+λ_{MSE}L_{MSE}

wherein λ_{adv}∈(0,1) and λ_{MSE}∈(0,1).
therefore, the loss function of the entire generative adversarial network is:

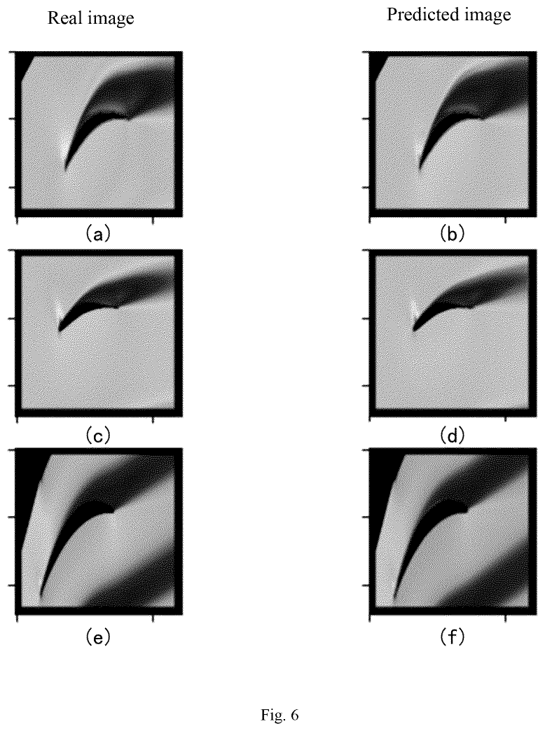

Lₜₒₜₐₗ=L_{D}+L_{G}
S4.4 saving the generative adversarial network trained in step S4.3 and testing on the validation dataset; adjusting the hyperparameter of the model according to an evaluation index of the validation dataset; adopting a structural similarity (SSIM) index as the evaluation index; and saving a model which makes the evaluation index optimal to obtain a final generative adversarial network prediction model;
two images x and y are provided, and the SSIM index is:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )}$$

wherein μₓ is the average value of x; μ_{y} is the average value of y; σₓ² is the variance of x; σ_{y}² is the variance of y; σ_{xy} is the covariance of x and y. c₁=(k₁L)² and c₂=(k₂L)² are constants used to maintain the stability. L is the dynamic range of a pixel value. k₁=0.01 and k₂=0.03. The value range of SSIM is [0,1]; and if the value is close to 1, the structures of the two images are similar.
S5. Predicting test data by the prediction model;
S5.1 preprocessing the test dataset of step S1.1 according to steps in step S1, and adjusting data dimension of the test dataset according to input requirements in step S2.1 and step S3.1;
S5.2 predicting the image of the last frame of each test sample by the final generative adversarial network prediction model in step S4.4 to obtain the flow field prediction image in the plane cascade when the inlet attack angle is 10′;
S5.3 selecting three groups of samples from the test results; as shown in FIG. 6, (a), (c) and (e) are flow field images calculated and generated by CFD under the conditions of different blade profiles and Mach numbers when the inlet attack angle of the axial flow compressor is 10°, and (b), (d) and (f) are the corresponding prediction results. It can be seen that the predicted images are very similar to the real images, and the acceleration regions and turbulence around the blades, and the slow moving flow field can be well predicted. The MSE of the whole test dataset is 0.0012, and the average value of the SSIM evaluation index is 0.8667. The experiment proves that all parts of the prediction network structure achieve the predetermined goal and realize the prediction of the steady flow field; not only the evolution process of the flow field can be captured, but also the low-dimensional features can be presented as high-dimensional representations; and the spatial-temporal evolution of the flow field can be predicted.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A steady flow prediction method in a plane cascade based on a generative adversarial network, comprising the following steps:
S1. preprocessing simulation image data of a steady flow field in a plane cascade of an axial flow compressor, comprising the following steps:
S1.1 obtaining image data of the steady flow field in the plane cascade of the axial flow compressor through CFD simulation experiments; under the conditions of the same blade profile, Mach number and inlet flow angle, forming an image sequence as a sample from flow field images with the change of an inlet attack angle over time; serving as an equal length sequence input; to ensure the objectivity of test results, dividing simulation experimental data into a test dataset and a training dataset before processing;
S1.2 denoising the image data of the flow field;
S1.3 cutting the filtered flow field images to obtain the flow field image at the edge of the plane cascade, unifying the resolution of the cut images, and normalizing training dataset;
S1.4 in the image sequence of each sample, using a last frame as a target truth of image prediction, and using other frame images as network input values;
S1.5 dividing the training dataset into a training set and a validation set;
S2. constructing an Encoding-Forecasting network module, comprising the following steps:
S2.1 adjusting the dimension of each input sample in the training set as (seq_input, c, h, w), and adjusting the dimension of the target truth of image prediction as (seq_target, c, h, w), wherein seq_input is the length of an input image sequence, seq_target is the length of a predicted image sequence, c represents the number of image channels, and (h,w) is the image resolution;
S2.2 an Encoding network is composed of a plurality of encoding modules; each encoding module is composed of a down-sampling layer and a ConvLSTM layer; each ConvLSTM layer contains a plurality of ConvLSTM units; the output of the down-sampling layer is input to the ConvLSTM layer through a gated activation unit, and each encoding module is connected with each other through the gated activation unit; each encoding module learns the high-dimensional spatial-temporal features of the flow field image sequence, outputs low-dimensional spatial-temporal features and transmits the features to a next encoding module;
S2.3 a Forecasting network is composed of a plurality of decoding modules; the effect of the decoding modules is to expand the low-dimensional flow spatial-temporal features extracted by the encoding modules into high-dimensional features to achieve the purpose of finally reconstructing the high-dimensional flow field image; each decoding module is composed of an up-sampling layer and a ConvLSTM layer; each ConvLSTM layer contains a plurality of ConvLSTM units; the output of the ConvLSTM layer is input to the up-sampling layer through the gated activation unit, and each decoding module is connected with each other through the gated activation unit; each decoding module decodes the spatial-temporal features of the input image sequence extracted by the encoding module in the same position of the Encoding network, obtains the feature information of a historical moment and transmits the feature information to a next decoding module;
S2.4 outputting the spatial-temporal features of different dimensions in the extracted flow field image sequence in the plane cascade by different encoding layers of the Encoding network, and using the spatial-temporal features of different dimensions as initial state input of different decoding layers by the Forecasting network;
S2.5 to ensure that the input image and the predicted image have the same resolution, making the output features of the last decoding module in the Forecasting network pass through a convolutional layer, and activating by a ReLu activation function to generate and output a final predicted image; and using the final predicted image as a prediction result of Encoding-Forecasting network, with dimension of (N,seq_target,c,h,w), wherein N is the number of samples;
S3. constructing a deep convolutional network module, comprising the following steps:
S3.1 adjusting the target truth of image prediction in step S1.4 and the dimension of the prediction result of the Encoding-Forecasting network obtained in step S2.5 as (N*seq_target,c,h,w) and using the same as the input of the deep convolutional network;
S3.2 connecting the convolutional layer, a batch normalization layer and a LeakyRelu activation function sequentially to form a convolutional module, wherein the deep convolutional network module is composed of a plurality of convolutional modules and an output mapping module, and the output mapping module makes the features extracted by the plurality of convolutional modules pass through a convolutional layer, uses a sigmoid activation function to obtain an output value between 0 and 1, and then performs dimensional transformation on the output value to obtain a probability output value; and using the probability output value as the final output of the deep convolutional network module with dimension of (N*seq_target,1), wherein the probability value represents a probability that the deep convolutional network determines that the image is a true image, and is marked as 1 for the true image and 0 for the predicted image of the Encoding-Forecasting network;
S4. constructing a generative adversarial network prediction model, comprising the following steps:
S4.1 using a generative adversarial network training mode so that the deep convolutional network module provides a learning gradient for the Encoding-Forecasting network and optimizes the parameters of the Encoding-Forecasting network; using the Encoding-Forecasting network constructed in step S2 as a generator of the generative adversarial network, marked as G; and using the deep convolutional network module constructed in step S3 as a discriminator of the generative adversarial network, marked as D;
S4.2 using a strategy of individually training the Encoding-Forecasting network, and adding the deep convolutional network module as the discriminator for forming a generative adversarial network for joint training when an error value is less than 0.001, to achieve the purpose of stabilizing a training process and further restoring the details of the flow field image;
S4.3 when the training error of the Encoding-Forecasting network module in step S4.2 is less than 0.001, forming the generative adversarial network from the network module and the deep convolutional network module for training; in the training process:
the discriminator uses a discriminator part L D in a traditional generative adversarial network loss function for training, with a calculation mode as follows:
$${L}_{D} = - V ( D , G ) = - \frac{1}{N} \sum [ log ( D ( Y ) ) + log ( 1 - D ( G ( X ) ) ) ]$$
for the unstable training of the generator in the generative adversarial training, an improved generator loss function is provided; the improved generator loss function is composed of two parts:
one part is a generator part L_{adv} in the traditional generative adversarial network loss function, with a calculation mode as follows:
$${L}_{adv} = V ( D , G ) = \frac{1}{N} \sum log ( 1 - D ( G ( X ) ) )$$
the other part is an MSE loss function L_{MSE}, which is used to ensure the stability of generator model training; at the same time, weight parameters λ_{adv} and λ_{MSE} are used to adjust the loss function L_{adv} and L_{MSE} to achieve the purpose of balancing the training stability and the clarity of the prediction result, and then the final loss function of the generator is:
L_{G}=λ_{adv}L_{adv}+λ_{MSE}L_{MSE}
wherein λ_{adv}∈(0,1) and λ_{MSE}∈(0,1);
therefore, the loss function of the entire generative adversarial network is:
Lₜₒₜₐₗ=L_{D}+L_{G}
S4.4 saving the generative adversarial network trained in step S4.3 and testing on the validation set; adjusting the hyperparameter of the model according to an evaluation index of the validation set; adopting a structural similarity SSIM index as the evaluation index; and saving a model which makes the evaluation index optimal to obtain a final generative adversarial network prediction model;
S5. predicting test data by the prediction model;
S5.1 preprocessing the test dataset of step S1.1 according to steps in step S1, and adjusting data dimension of the test dataset according to input requirements in step S2.1 and step S3.1;
S5.2 predicting the image of the last frame of each test sample by the final generative adversarial network prediction model in step S4.4 to obtain the flow field prediction image in the plane cascade when the inlet attack angle is 10°.

2. The steady flow prediction method in the plane cascade based on the generative adversarial network according to claim 1, wherein in the step S1.2, median filtering, mean filtering and Gauss filtering are used to denoise the flow field image data.

3. The steady flow prediction method in the plane cascade based on the generative adversarial network according to claim 1, wherein in the step S1.5, the training dataset is divided into the training set and the validation set in a ratio of 4:1.

4. The steady flow prediction method in the plane cascade based on the generative adversarial network according to claim 1, wherein in the step S4.2, the Encoding-Forecasting network is trained individually by the MSE loss function, and the MSE loss function is:
$${L}_{MSE} = \frac{1}{N} \sum {( G ( X ) - Y )}^{2}$$
wherein X=(X¹, . . . , X^{m}) represents the input image sequence, Y=(Y¹, . . . Yⁿ) represents a prediction target image sequence, G(X) represents the predicted image sequence of the Encoding-Forecasting network, and N is the number of samples.

5. The steady flow prediction method in the plane cascade based on the generative adversarial network according to claim 1, wherein in the step S4.4, two images x and y are provided, and the SSIM index is:
$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )}$$
wherein μₓ is the average value of x; μ_{y} is the average value of y; σₓ² is the variance of x; σ_{y}² is the variance of y; σ_{xy} is the covariance of x and y; c₁=(k₁L)² and c₂=(k₁L)² are constants used to maintain the stability; L is the dynamic range of a pixel value; k₁=0.01; k₂=0.03; the value range of SSIM is [0,1]; and if the value is close to 1, the structures of the two images are similar.
